(19) United States
(12) Patent Application Publication
(10) Pub. No.: US 2004/0124571 A1
(43) Pub. Date: Jul. 1, 2004

(54) Gas spring damper unit for a motor vehicle

(76) Inventors: Henning Gold, Wohnsitz (DE); Patrik Braun, Wohnsitz (DE); Peter Kobs, Wohnsitz (DE); Jurgen Berg, Wohnsitz (DE)

Correspondence Address: Horst Kasper, 13 Forest Drive, Warren, NJ, 07059, US

(21) Appl. No.: 10/675,520

(22) Filed: Sep. 30, 2003

Related U.S. Application Data
(63) Continuation-in-part of application No. PCT/DE02/01101, filed on Mar. 26, 2002.

(30) Foreign Application Priority Data
Mar. 30, 2001 (DE) 101 15 980.3

(51) Int. Cl. F16F 9/18

(52) U.S. Cl. 267/124

(57) ABSTRACT

Gas spring damper units have flow limiting valves, which are either constant flow drillings or spring loaded non-return valves. Said solutions either do not permit a damping behavior which is dependent upon the direction of displacement or are too complicated and expensive. According to the Invention, the flow limiting valves (15) thus each have a different flow resistance depending upon the direction of flow and the flow resistance of each flow limiting valve (15) is set in at least one direction such that the critical Reynolds number for the transition from laminar flow to turbulent flow lies within the pressure difference across the flow limiting valve (15) as determined by the possible piston speeds.

The Invention relates to a gas spring damper unit according to the preamble of claim 1.

Gas spring damper unit of this kind are employed predominantly in the motor vehicle technology, for example for the wheel suspension or also for a spring supported driver seat.

Gas spring damper units are in principle known in a three chamber construction with a spring chamber carrying the load and two oppositely disposed damper chambers as well as with a two chamber construction having a combined spring damper chamber and a damper chamber on the other hand.

A gas spring damper unit in the two chamber construction is known for example from the German printed Patent document DE 3641623 A1. This two chamber gas spring damper unit is provided for a wheel suspension and comprises a cylindrical casing with a cover and a double acting piston fitted into the casing. The piston has a piston rod on one side, wherein the piston rod penetrates the cover of the casing. The casing on the one hand and the piston rod on the other hand are solidly connected to one body part or, respectively, to the wheel suspension, wherein the freely disposed part of the piston rod is covered by bellows. For this purpose, the bellows are attached on the one hand to a cover of the casing and on the other hand at the head of the piston rod.

The piston subdivides the cylinder chamber of the casing into a decreasing pressure chamber and an increasing pressure chamber during spring compression, wherein one of the pressure chamber is connected toward the outside with a compressed air source through a casing connector and wherein the pressure chambers are connected to each other through one or several overflow throttles disposed in the piston.

These overflow throttles are formed out of a plurality of simple axial throttle bore holes, wherein the throttle bore holes are disposed on a common part circle and wherein the throttle bore holes have the same throttling effect relative to the balancing air stream in two directions of motion. The piston motion is thereby damped to the same extend in both directions. This is disadvantageous because of the required floor attachment of the wheels there is desired a smaller damping motion for the spring compression as compared to the spring decompression. A further disadvantage is based on the situation that the throttle bore holes represent constant throttles and therefore work depending on the speed of the cylinder piston. This means that the increase in the throttling effect decreases with increasing piston speed.

These requirements are met by an overflow throttle which is shown in the German printed Patent document DE 8413300 U1. This overflow throttle comprises a central throttle bore hole with an annular chamber, wherein the annular chamber is covered by a flexible ring disk. This ring disk heads on the one hand an outer stop face and on the other hand an inner stop face, such that the ring disk lifts off from the respective stop face in one flow-through direction at the outer rim and in the other flow-through direction at the inner rim. Different lever arms result by the different distance of the two stop faces relative to the center of the ring disk, wherein the different lever arms effect a different opening characteristic for the two flow-through directions. In case of a proper selection of the spring force of the ring disk, the throttling effect and there with the damping force remains equal over the complete speed region of the cylinder piston.

The overflow throttles require however a large technical production expenditure, since initially very complicated channel guidings are required. In addition, the ring disk has to be held and guided in a most difficult way such that the outer edge region and the inner edge region of the ring disk perform alternatively a sealing function or holding function. This again increases the costs of production. It is to be added that an additional part is required with the ring disk, which also effects negatively on the production costs. It is a deficiency in a functional perspective that the ring disk is a moving part, which is subject to wear and therefore has only a limited lifetime.

Therefore it is an object of the present Invention to develop a gas spring damper unit of the kind recited, which has an about equal remaining damping force over the complete speed region of the cylinder piston, which has a different damping behavior in the two directions of motion of the cylinder piston and which is simple and cost favorably produceable.

These and other objects and advantages of the present invention will become evident from the description which follows.

### BRIEF DESCRIPTION OF THE INVENTION

The present invention provides a new gas spring damper unit. The new gas spring damper unit eliminates the recited disadvantages of the state-of-the-art.

The particular advantage comprises here that the advantages of a throttle opening with a closure element and the advantages of an open throttle opening are combined. Thus there are present open bottle openings present at the new overflow throttles, wherein the open talk to openings are not subject to wear and therefore not sensitive to interference and exhibit an unlimited lifetime. The expenditure for production of the new overflow throttles is small.

Functionally it is accomplished that the gas passes through the overflow throttles at small loads of the cylinder piston with a laminar kind of flow. The therewith obtained damping forces are also relatively small because of the small pressure difference over the overflow throttles and because of the small pressure losses based on the laminar flow. This is an advantage. The pressure difference over the overflow throttles increases with higher loads of the cylinder piston and therewith also the flow resistances increase. The laminar flow changes into a turbulent flow based on the special construction and dimensioning of the overflow throttles at the pre-calculated load of the cylinder piston, whereby the flow resistance is additionally increased. This additional flow resistance increases again the desired damping forces in the upper speed region of the cylinder piston. This is also desired and an advantage.

Reference can be made to all known and possible possibilities for the particular construction of the overflow throttles, which possibilities have influence on the overall flow resistance. Amongst these are for example of the length, the cross-section, the cross-section shape, the longitudinal shape, and in the material and the surface properties of the wall of the overflow throttles.

The functional operating center of gravity of all flow resistances of at least two of the overflow throttles can in a particular way be displaced outside of the radial center line of the cylinder piston, and then different flow resistances and therewith different damping forces occur for the two directions of flow. This is also desired and always then an advantage, where different speeds are required for the two directions of motion of the cylinder piston.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

In the accompanying drawing, in which are shown several of the various possible embodiments of the present invention:

The Invention is to be explained in more detail by way of an embodiment.

For this purpose there is shown:

FIG. 1: a gas spring damper unit in the two chamber construction in a sectional view

FIG. 2: the piston of the gas spring damper unit in a top planar view

FIG. 3: a first embodiment of an overflow throttle

FIG. 4: a second embodiment of an overflow throttle, and

FIG. 5: a third embodiment of an overflow throttle.

FIG. 6: a sectional view of a throttle with double conical sections

FIG. 7 is a sectional view of a nozzle according to the state of the art;

FIG. 8 is a view similar to that of FIG. 3 with additional designations.

### DESCRIPTION OF INVENTION AND PREFERRED EMBODIMENT

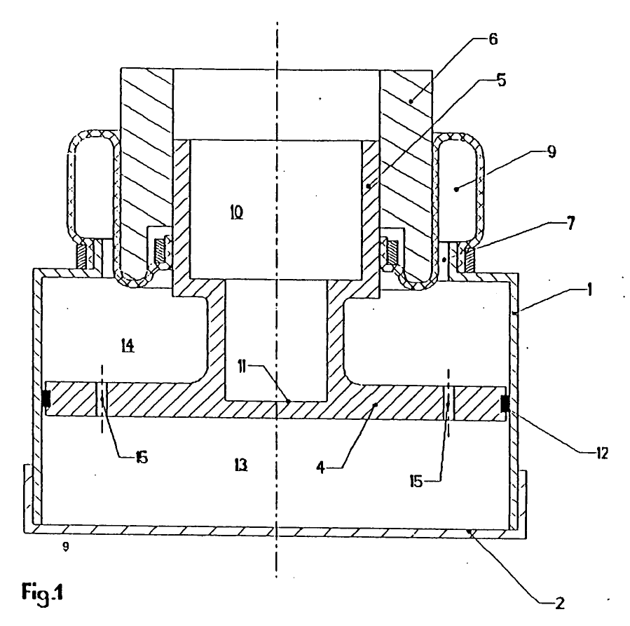

As shown in FIG. 1 the two chamber gas spring damper unit has a cylinder casing 1 with a casing foot 2 on the one hand side and the casing cover 3 on the other hand side. The casing foot 2 is connected to the vehicle body or to the wheel suspension over elements not illustrated here. An axially shiftable guided cylinder piston 4 with a piston rod 5 and the roll off piston 6 is disposed in the cylinder casing 1. The piston rod 5 and the roll off piston 6 are solidly connected to each other and jointly penetrate the casing cover 3 of the cylinder casing 1.

The piston rod 5 and the roll off piston 6 are dimensioned in their radial extensions such that a throttle free annular channel 7 remains between the roll off piston 6 and the casing cover 3. This annular channel 7 is pressure tight closed toward the outside by an air spring bellows 8, wherein the air spring bellows 8 comprises a long wearing and flexible material and which air spring bellows 8 are on the one hand attached to the casing cover 3 and on the other hand to the piston rod 5. This air spring bellows 8 exhibits such a spatial extension that the bellows form a bellows chamber 9 outside of the cylinder casing 1 and seals the cylinder casing 1 with this bellows chamber 9. The piston rod 5 is furnished with a hollow chamber 10 for reasons of shortening the incorporation height, wherein the hollow chamber 10 at its space has a force engagement face 11 for connecting to the vehicle body or to the wheel suspension.

The cylinder piston is furnished at its circumference with a sealing element 12, whereby the inner chamber of the cylinder casing 1 is subdivided into a spring damper chamber 13 becoming smaller upon spring compression and into a damper chamber 14 becoming larger upon spring compression.

This damper chamber 14 is connected to the bellows chamber 9 through the already mentioned annular channel 7. Several overflow throttles 15 are disposed in the cylinder piston 4, wherein the overflow throttles 15 corner the spring damper chamber 13 and the damper chamber 14 in a particular way to each other. An external gas source in connection with a gas connector not specially shown takes care that a predetermined gas pressure is built up and is maintained in the inner chambers of the gas spring damper unit.

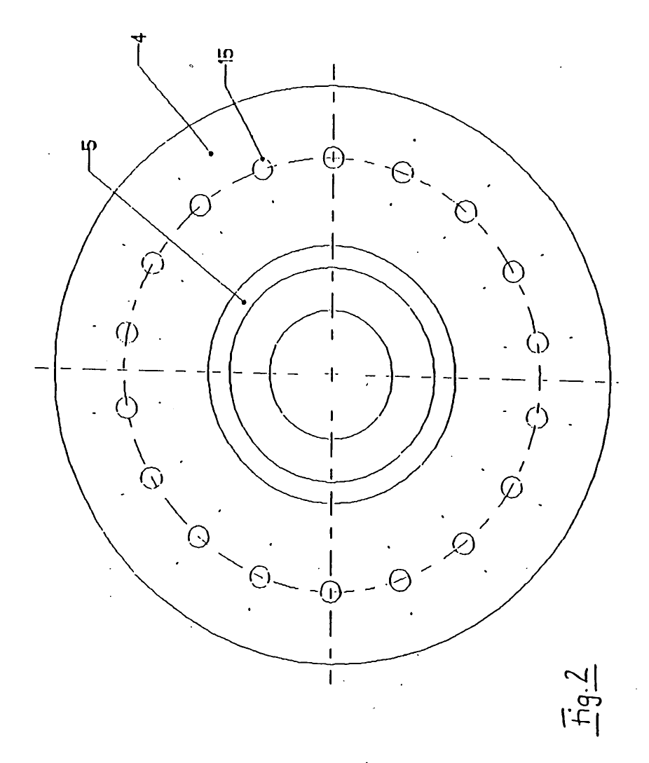

FIG. 2 shows a selected arrangement of these overflow throttles 15, wherein all overflow throttles 15 are disposed on a common part circle of the cylinder piston 4 and are placed at a uniform distance from each other.

These overflow throttles 15 have the purpose to enable a volume balancing between the spring damper chamber 13 and the damper chamber 14 in case of corresponding motions in the two directions of the cylinder piston 4 and therewith to obtain a damped motion of the cylinder piston 4 by a throttling of the passing through gas stream. Correspondingly, the one or several overflow throttles 15 are attuned in their cross-section, their length and their shape in a particular way to the respective application situation. The overflow throttles 15 perform furthermore the task to develop different throttle effects in the two flow through directions and therewith to develop different damping forces.

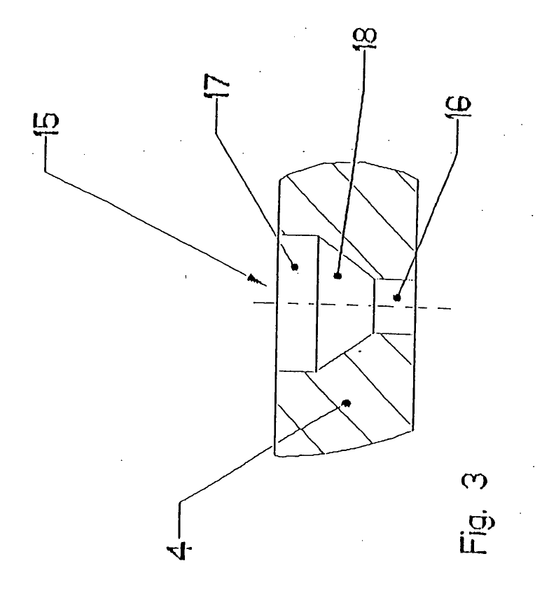

In connection therewith the FIGS. 3 through 5 show a selection of corresponding embodiments. According to FIG. 3, one or several overflow throttles are each in the same way furnished as a cylindrical bore hole with a cylindrical cross-section narrowing 16 and a cylindrical cross-section expansion 17. A conical cross-section 18 is disposed between the cross-section narrowing 16 and the cross-section expansion 17, wherein the conical cross-section 18 adapts slowly and continuously in diameter to the cross-section narrowing 16 and the cross-section expansion 17. Preferably at least these overflow throttles 15 are aligned such that all cross-section narrowings 16 are disposed outside of the radial central axis and on the same side of the cylinder piston 4.

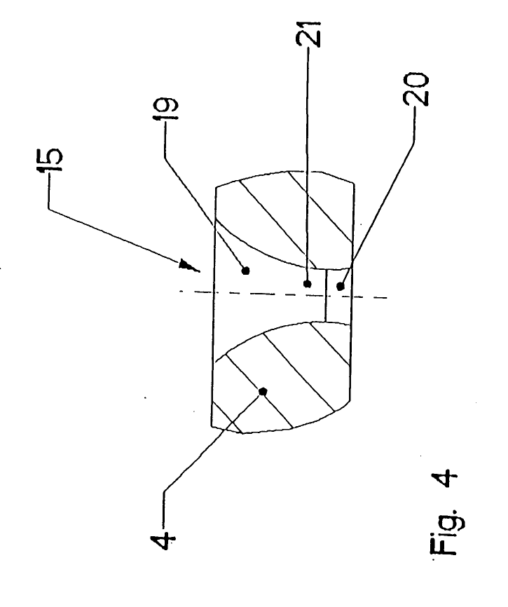

One or several of the overflow throttles 15 comprise a bore hole with a first conical cross-section 19 and a second conical cross-section 20, wherein the two conical cross-sections 19 and 20 are disposed opposite to each other according to FIG. 4 in the kind of a Laval nozzle. The two cross-sections 19,20 are connected to each other through a rounded cross-section narrowing 21. This rounded cross section narrowing 21 is disposed in the region outside of the radial center axis of the cylinder piston 1, that is outside of the half length of the throttle of the overflow throttle 15. Preferably the rounded cross-section narrowings 21 of these overflow throttles 15 are disposed on the same side of the cylinder piston 4.

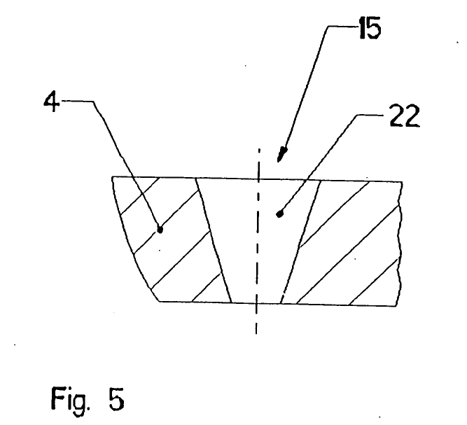

The overflow throttles 15 is a conical bore hole 22 extending over the complete with off the cylinder piston 4 according to FIG. 5. Preferably the conical bore holes 22 of all overflow throttles 15 are disposed in the same direction.

It is common to all embodiments of overflow throttles shown in FIGS. 3 to 5 and derivable thereof that all sizes and values influencing the flow resistance such as length, cross-section, geometric cross-sectional shape for the surface the properties of each overflow throttle 15 are furnished such that the characterizing critical Reynold number, characterizing the transition of the laminar flow kind into the turbulent flow kind of the gas, is disposed within the pressure differences over the overflow throttle 15, which pressure differences can occur based on the different speeds of the cylinder pistons 4. Here are certain number or all overflow throttles 15 are furnished with cross-sectional narrowings 16, 21, which are always disposed outside of the radial center axis and on the same side of the cylinder piston 4. The selection of the number of the overflow throttles equipped with a cross-sectional narrowing 16, 21 depends in the case of a desired and uniform force distribution also on the uniform distribution on the common part circle.

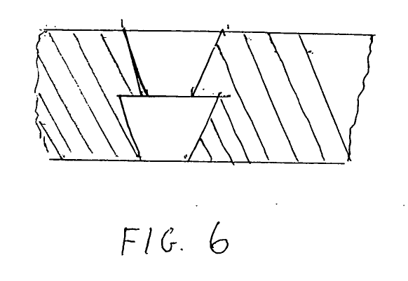

The bore hole of the throttle of FIG. 6 shows two successive conical sections of similar dimensions. Alternatively up to about 5 successive conical section can follow each other in such a bore hole.

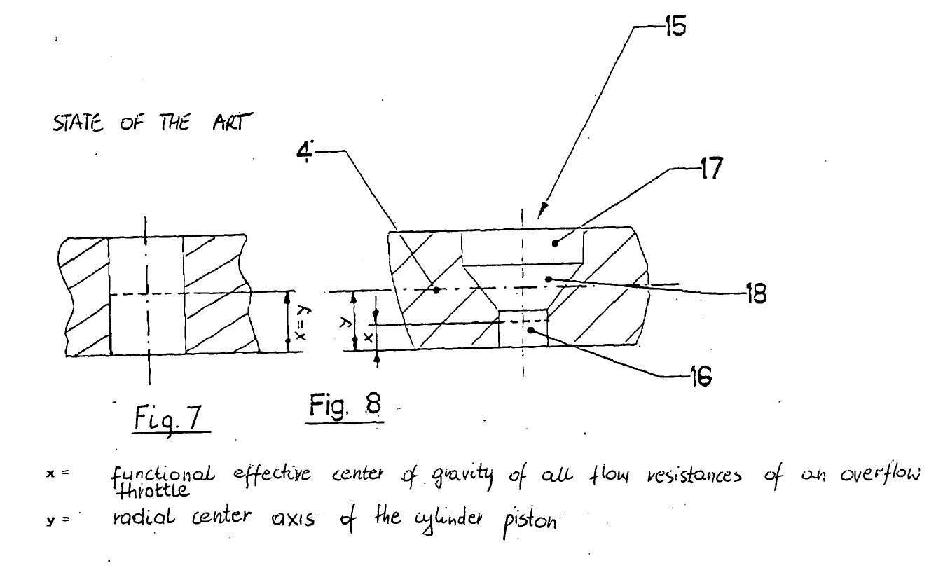

The over flow throttle according to FIG. 7 exhibits a radial center axis (y) of the cylinder piston at half height level of the cylinder piston or a radial line disposed in a plane perpendicular to the bore hole axis and disposed in the axial middle of the bore hole. The state of the art throttle of FIG. 7 exhibits the same throttle resistance and therewith the same damping force independent of the direction of flow in the bore hole of the throttle. Therefore, the functional effective center of gravity 9x) of the overflow throttle is disposed at half the length of the throttle bore hole. Therefore, according to the state of the at the functional center of gravity (y) of the over flow throttle is disposed on the radial center axis (x) of the cylinder piston.

The FIG. 8 shows the asymmetrical bore hole throttle according to the present invention, where the largest cross-section narrowing is placed at the edge of the cylinder piston such that the functional effective center of gravity (x) adjusts itself to become located outside of the radial center axis (y) of the cylinder piston. Different flow resistances and thereby different damping forces result depending on the direction in which the flow passes through the over flow throttle. The different damping forces are intended with gas spring damping units.

The two throttle shapes are associated with the disadvantage of a constant form of the throttle, where the throttle effect does not increase in the same measure as the stroke speed of the cylinder piston increases. In order to eliminate this disadvantage the bore hole of the throttle should be constructed that the type of flow switches from laminar to turbulent at a certain piston speed. This kind of turbulent flow generates an additional and desired flow resistance, where the increase of the flow resistance adapts in its slope again to the increase in piston speed.

The subject matter of the present invention distinguishes from the overflow throttle shown in FIG. 7.The throttle according to FIG. 7 is employed as several axially directed throttle bore holes, which exhibit equal throttle effects in the two possible flow through directions. The overflow throttles according to FIG. 7 are simple constant value throttles, which are working depending on the speed of the cylinders. This means that an increase in the throttling effect becomes smaller with increasing piston speed.

This feature is not desirable with gas spring damper units. It is desirable to furnish a gas spring damper unit having an about equally remaining damping force over the complete speed region of the cylinder piston. This effect is essentially accomplished with a spring loaded over flow throttle.

The bore hole of the throttle according to the present invention with the cross-sectional narrowing furnishes such a flow resistance, wherein the flow resistance is such that upon a certain speed of the piston the type of flow of the gas jumps from laminar flow to turbulent flow. This turbulence accomplishes an additional flow resistance, wherein the additional flow resistance retains the increase in throttling effect constant also in the upper region of the piston speed.

The overflow throttle (15) according to the present invention has a difference of flow resistance such that the flow resistance in a higher flow resistance direction is at least about 5 percent higher as the flow resistance in a lower flow resistance direction. Preferably, the flow resistance in the higher flow resistance direction is at least about 30 percent higher as the flow resistance in the lower flow resistance direction. More preferably, the flow resistance in the higher flow resistance direction is at least about 100 percent higher as the flow resistance in the lower flow resistance direction. Even more preferred is the situation, where the flow resistance in the higher flow resistance direction is at least about 500 percent higher as the flow resistance in the lower flow resistance direction.

According to the present invention, the cone face angle relative to the longitudinal axis of the bore hole of the throttle in FIGS. 3 and/or 5 can be from 10 degrees to 70 degrees and preferably from 30 to 60 degrees and more preferably from 40 to 50 degrees. In a diameter changing bore hole of a throttle as shown by way of example in FIGS. 3, 4 and 5, the diameter of the bore hole can change from a lower opening to an upper opening by a ratio of from 1 to 10 up to a ratio of 1 to 1.2 and is preferably in a range of from 1 to 5 up to 1 by 2 and preferably in a range of 1 to 4 up to 1 to 3. Alternatively, in an opening face changing bore hole of a throttle, the diameter can change from a lower opening to an upper opening by a ratio of from 1 to 50 up to a ratio of 1 to 1.5 and is preferably in a range of from 1 to 20 up to 1 by 4 and preferably in a range of 1 to 10 up to 1 to 6.

In a curved bore hole according to FIG. 4, the curvature can be convex as is shown in FIG. 4 and alternatively concave. The size of the radius of curvature in an axial section of the bore hole as for example shown in FIG. 4 from 0.5 times the thickness of the piston plate or the length of the bore hole to 10 times The length of the bore hole and the radius of curvature is preferably from 1 times the length of the bore hole to 5 times the length of the bore hole.

The flow mass in the direction of less flow resistance of the bore hole can be from about 1.2 to 20 times the gas weight throughput in the direction of higher flow resistance and is preferably from 3 to 10 times the gas weight throughput of the direction of higher flow resistance at the relevant piston speeds of concern.

List of Reference Characters

1 cylinder casing

2 casing foot

3 casing cover

4 cylinder piston

5 piston rod

6 roll off piston

7 annular channel

8 air spring bellows

9 bellows chamber

10 hollow chamber

11 force engagement face

12 sealing element

13 spring damping chamber

14 damping chamber

15 overflow throttle

16 cross-section narrowing

17 cross-section expansion

18 conical cross-section

19 first conical cross-section

20 second conical cross-section

21 rounded cross-section narrowing

22 conical bore hole

1. Gas spring damper unit for a motor vehicle comprising a cylinder casing (1) and a cylinder piston (4) shiftable in the cylinder casing (1) and having a piston rod (5), wherein the cylinder piston (4) is sealed relative to the cylinder casing (4) by a sealing element (12) and wherein the piston rod (5) is connected to the cylinder casing (1) by rolling bellows (8), where by a spring damper chamber (13) becoming smaller upon spring compression and a damper chamber (14) becoming larger upon spring compression are formed, wherein the two chambers are connected by a throttle acting in two directions and disposed in the cylinder piston (1) and wherein this throttle comprises one or several overflow throttles (15), characterized in that
the overflow throttles (15) have in each case a flow resistance different relative to the flow through direction, and
the flow resistance of each of the overflow throttles (15) is dimensioned such in at least one of the passing through directions that the critical Reynolds number for the transition from the laminar into the turbulent kind of flow is disposed within the pressure difference over the overflow throttle (15), wherein the pressure difference is predeterminable from the possible piston speeds.

2. Gas spring damper unit according to claim 1, characterized in that the functional effective center of gravity of all flow through resistances of the flow through throttle (15) is disposed at a point outside of the radial center axis of the cylinder piston (4) and on the same side of the cylinder piston (4).

3. Gas spring damper unit according to claim 2 characterized in that the functional effective center of gravity of all flow resistances of the overflow throttles (15) is disposed on the side of the spring damper chamber (13) decreasing in size.

4. Gas spring damper unit according to claim 3 characterized in that the flow resistance of each over flow throttle (15) is determined by the length of the throttle, the cross-section of the throttle, the shape of the throttle and/or the wall properties of the throttle.

5. Gas spring damper unit for a motor vehicle comprising a cylinder casing (1) and a cylinder piston (4) shiftable in the cylinder casing (1) and having a piston rod (5), wherein the cylinder piston (4) is sealed relative to the cylinder casing (4) by a sealing element (12) and wherein the piston rod (5) is connected to the cylinder casing (1) by rolling bellows (8), where by a spring damper chamber (13) becoming smaller upon spring compression and a damper chamber (14) becoming larger upon spring compression are formed, wherein the two chambers are connected by a throttle acting in two directions and disposed in the cylinder piston (1) and wherein this throttle comprises one or several overflow throttles (15), characterized in that
the overflow throttles (15) have in each case a different flow resistance relative to the flow passage direction, and
the overflow throttles (15) comprising in each case a passing through throttle bore hole with at least one cross-sectional narrowing, wherein
the functional effective center of gravity of all flow resistances of the overflow throttle (15) is disposed at a point outside of the radial central axis of the cylinder piston (4), and
the throttle bore hole is dimensioned such that critical Reynolds number for the transition from the laminar flow kind to the turbulent flow kind occurs within the possible piston speeds and in at least one passage flow direction.

6. Gas spring damper unit according to claim 5 characterized in that the functional effective center of gravity of all flow resistances of the flow through throttle (15) is disposed on the same side of the cylinder piston hole (4).

7. Gas spring damper unit according to claim 6 characterized in that the functional effective center of gravity of all flow resistances of the overflow throttle (15) is disposed on the side of the smaller becoming spring damper chamber (13).

8. Gas spring damper unit according to claim 7 characterized in that the flow resistance of each overflow throttle (15) is determined by the length of the throttle, the cross-section of the throttle, the shape of the throttle and/or the wall properties of the throttle.

9. A gas spring damper unit for a motor vehicle comprising
a cylinder casing (1);
a cylinder piston (4) shiftable in the cylinder casing (1) and having a piston rod (5) attached;
a sealing element (12), wherein the cylinder piston (4) is sealed relative to the cylinder casing (4) by the sealing element (12);
rolling bellows (8) connecting the piston rod (5) to the cylinder casing (1);
whereby a spring damper chamber (13) becoming smaller upon spring compression and a damper chamber (14) becoming larger upon spring compression are formed;
a general throttle connecting the spring damper chamber (13) to the damper chamber (14), wherein the general throttle acts in two directions and is disposed in the cylinder piston (1) and wherein the general throttle includes an overflow throttle (15) having a difference of flow resistance such that the flow resistance in a higher flow resistance direction is at least about 5 percent higher as the flow resistance in a lower flow resistance direction.

10. The gas spring damper unit according to claim 9 wherein the overflow throttle (15) is formed by a bore hole, has a flow resistance relative to the flow passage direction such that the gas weight throughput in the direction of less flow resistance of the bore hole can be from about 1.2 to 20 times the gas weight throughput in the direction of higher flow resistance

11. The gas spring damper unit according to claim 9 wherein
the diameter of a bore hole of the overflow throttle (15) is disposed from a first opening of the bore hole to an second opening of the bore hole within a ratio of from 1 to 10 up to a ratio of 1 to 1.2.

12. The gas spring damper unit according to claim 11
wherein
the functional effective center of gravity of all flow resistances of the overflow throttle (15) is disposed at a point outside of a radial central axis of the cylinder piston (4).

13. The gas spring damper unit according to claim 9 wherein
a bore hole of the throttle (15) is dimensioned such that a transition from a laminar flow to a turbulent flow occurs within possible piston speeds and in a passage flow direction having a higher flow resistance.

14. The gas spring damper unit according to claim 9 wherein a functional effective center of gravity of all flow resistances of the over flow throttle (15) is disposed on a same side of a cylinder piston hole (4).

15. The gas spring damper unit according to claim 14 wherein the functional effective center of gravity of all flow resistances of the overflow throttle (15) is disposed on the side of the smaller becoming spring damper chamber (13).

16. The gas spring damper unit according to claim 15 wherein the flow resistance of each overflow throttle (15) is determined by the length of the throttle, the cross-section of the throttle, the shape of the throttle and/or the wall properties of the throttle.

17. The gas spring damper unit according to claim 9 wherein a bore hole of the overflow throttle (15) has a conical section and wherein a cone face of the conical section is disposed at a cone angle from about 10 to about 70 degrees relative to a longitudinal axis of the bore hole of the throttle (15).
